(19) United States
(12) Patent Application Publication
(10) Pub. No.: US 2012/0110831 A1
(43) Pub. Date: May 10, 2012

(54) METHOD AND SYSTEM FOR REPLACING AN ENERGY CONTAINER SUPPLYING POWER TO A DRIVING ENGINE OF AN AUTOMOBILE

(75) Inventor: Bruno Escande, Septeuil (FR)

(73) Assignee: Renault S.A.S., Boulogne Billancourt (FR)

(21) Appl. No.: 13/382,057

(22) PCT Filed: Jun. 22, 2010
(86) PCT No.: PCT/FR2010/051268

§ 371 Date: Jan. 3, 2012

(30) Foreign Application Priority Data
Jul. 3, 2009 (FR) 0954582

(51) Int. Cl. B60S 5/06; B23P 19/00

(52) U.S. Cl. 29/592.1; 29/759

(57) ABSTRACT

The invention relates to a method for replacing an energy container supplying power to a driving engine of an automobile resting on the ground and including a longitudinal axis, a transverse axis and a vertical axis, the replacement method including a first step of positioning the automobile relative to the ground without any action from the driving engine of the automobile, characterised in that said method includes a step of releasing the linking restraints linking the energy container to the automobile.

The present invention relates to a method for replacing an energy container for powering a motor for driving a motor vehicle.

Certain motor vehicles, such as electric or hybrid vehicles, comprise an energy container for powering a driving motor, such as an electric battery for powering an electric motor. It may be found to be worthwhile to exchange this container when its energy level is low against a new container filled with energy. This may be done in a station similar to a service station in which it is possible to fill a gasoline tank of a motor vehicle.

From document U.S. Pat. No. 5,612,606, a station is known for exchanging an electric battery for powering a motor for driving an electric vehicle and a method is known for carrying out such an exchange. In the exchange station described, the driver positions the vehicle approximately in a rail, against a longitudinal stop relative to the items of equipment of the station. Subsequently, in more or less automatic phases, movable means for taking off the electric battery and for assembling the new battery to the vehicle position themselves relative to the vehicle by virtue of sensors. The quantity of sensors and electronic means necessary for such a station to operate makes it difficult to make it reliable and implies that its operation is not very robust.

For an easy deployment of the stations for exchanging an energy container (requiring little technological skill), it is necessary to make the operation of these stations reliable and robust.

Therefore, the object of the invention is to provide a method for replacing containers that remedies the drawbacks mentioned above and improves the known replacement methods of the prior art. In particular, the invention proposes a simple, reliable and robust method for replacing energy containers. The invention also relates to a system for replacing energy containers. The invention further relates to a replacement station furnished with such a replacement system.

According to the invention, the method for replacing an energy container for powering a motor for driving a motor vehicle resting on a floor and comprising a longitudinal axis, a transverse axis and a vertical axis, the replacement method comprising a first step of positioning the motor vehicle relative to the floor in the absence of action of a motor for driving the motor vehicle, is characterized in that it comprises a step of withdrawing the constraining linkage elements linking the energy container to the motor vehicle.

Said step of withdrawing the constraining linkage elements may comprise a locking of means for absorbing vertical forces applied to the energy container and bringing a pallet into contact with the energy container, said pallet being previously positioned under the energy container of the motor vehicle.

Said locking of means for absorbing vertical forces may comprise the rotation of a removable element, capable of absorbing the vertical forces exerted by actuators, so that the attitude of the motor vehicle is not modified.

The first positioning step may comprise:
positioning the motor vehicle relative to the floor along the longitudinal axis, and/or
positioning the motor vehicle relative to the floor about the vertical axis.

The replacement method may comprise a second step of positioning a system for replacing an energy container for powering a motor for driving a motor vehicle relative to the motor vehicle.

The second positioning step may comprise:
positioning the replacement system relative to the motor vehicle along the transverse axis.

The replacement method may comprise a third step of precise positioning of the motor vehicle relative to the floor in the absence of action of a motor for driving the motor vehicle.

The third positioning step may comprise:
positioning the motor vehicle relative to the floor along the longitudinal axis, and/or
positioning the motor vehicle relative to the floor about the vertical axis,
   by interaction of positioning means.

The replacement method may comprise a fourth step of positioning the body of the motor vehicle relative to the floor.

The fourth positioning step may comprise:
positioning the body of the motor vehicle relative to the floor along the vertical axis, and/or
positioning the body of the motor vehicle relative to the floor about the longitudinal axis, and/or
positioning the body of the motor vehicle relative to the floor about the transverse axis.

The replacement method may comprise a fifth step of the energy container being taken over by the replacement system.

Said step of withdrawing the constraining linkage elements can be carried out after said fifth step of the energy container being taken over by the replacement system.

According to the invention, the system for replacing an energy container for powering a motor for driving a motor vehicle is characterized in that it comprises hardware means and/or software means for applying the replacement method defined above.

According to the invention, the station for replacing an energy container for powering a motor for driving a motor vehicle is characterized in that it comprises a replacement system defined above.

The appended drawings represent, as an example, two embodiments of a system for replacing energy containers according to the invention.

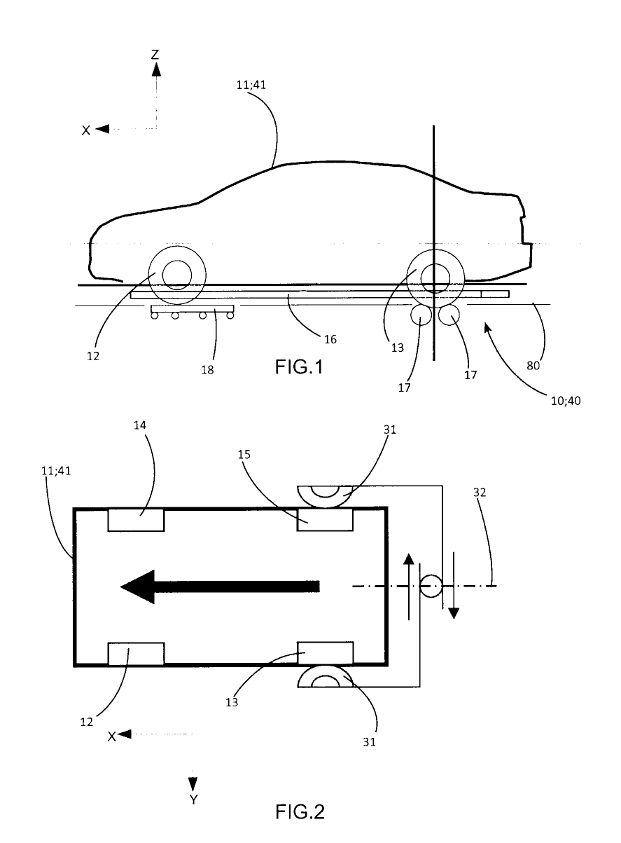

FIG. 1 is a schematic side view of an embodiment of a system for replacing energy containers according to the invention.

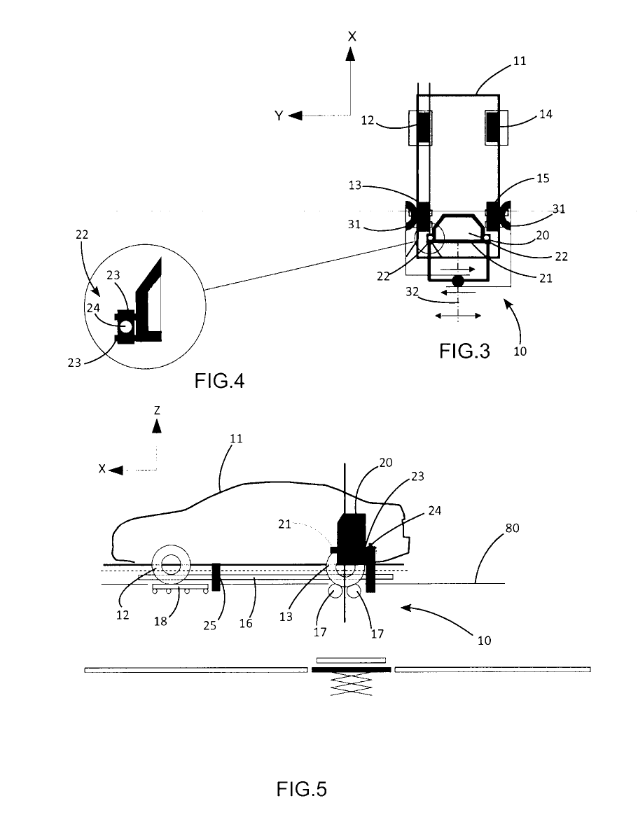

FIGS. 2 and 3 are schematic views from above of an embodiment of a system for replacing containers according to the invention.

FIG. 4 is a schematic detail view of a device for positioning a motor vehicle.

FIG. 5 is a schematic side view of a first embodiment of a system for replacing energy containers, a vehicle being positioned vertically by virtue of this system.

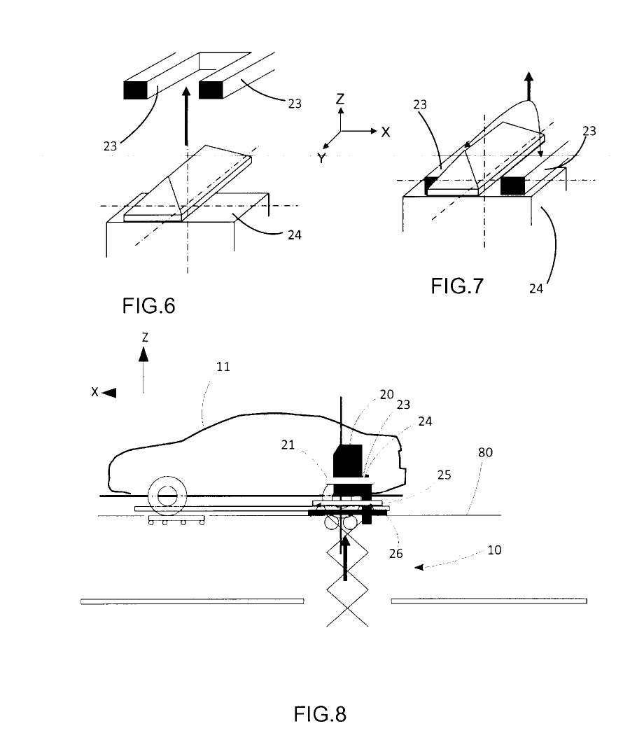

FIGS. 6 and 7 are schematic views of a means for locating a motor vehicle.

FIG. 8 is a schematic side view of the first embodiment of a system for replacing energy containers, an energy container of the vehicle being taken over by the replacement system.

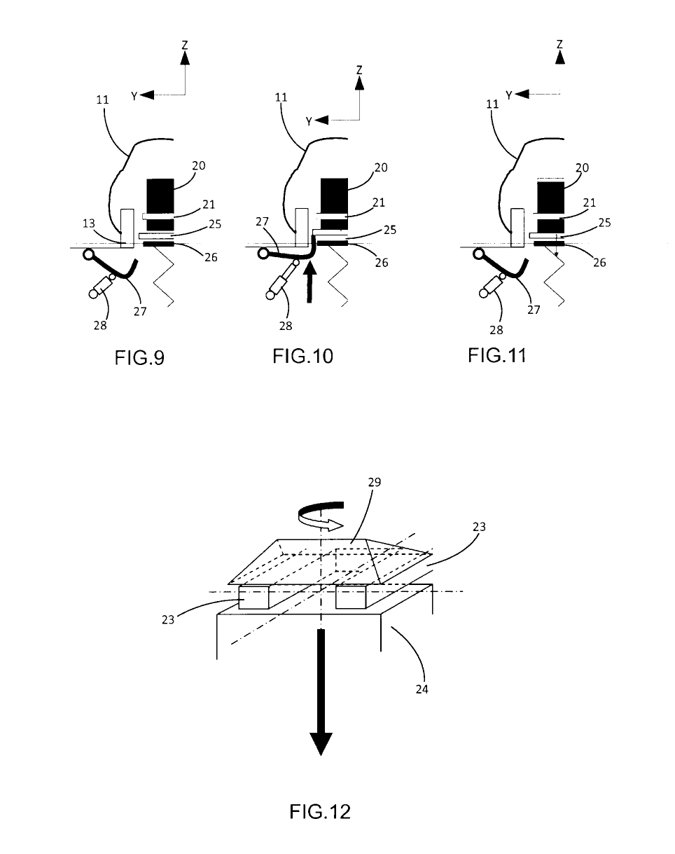

FIGS. 9 to 11 are schematic rear views of the first embodiment of a system for replacing energy containers, during a step of withdrawing the constraining elements used to connect the container to the vehicle.

FIG. 12 is a schematic view of a means of locating the motor vehicle, this locating means also performing another function.

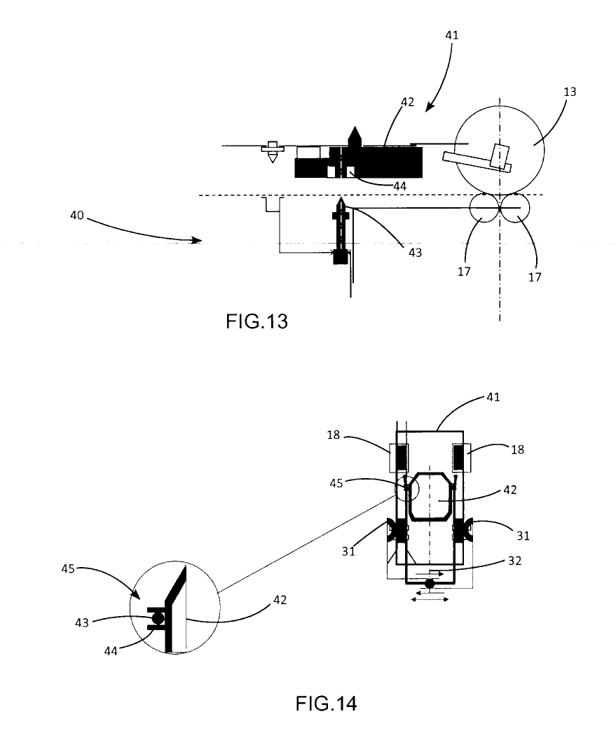

FIG. 13 is a schematic side view of a second embodiment of a system for replacing energy containers, a vehicle being in this system.

FIG. 14 is a schematic detail view from above of the second embodiment of the system for replacing containers according to the invention.

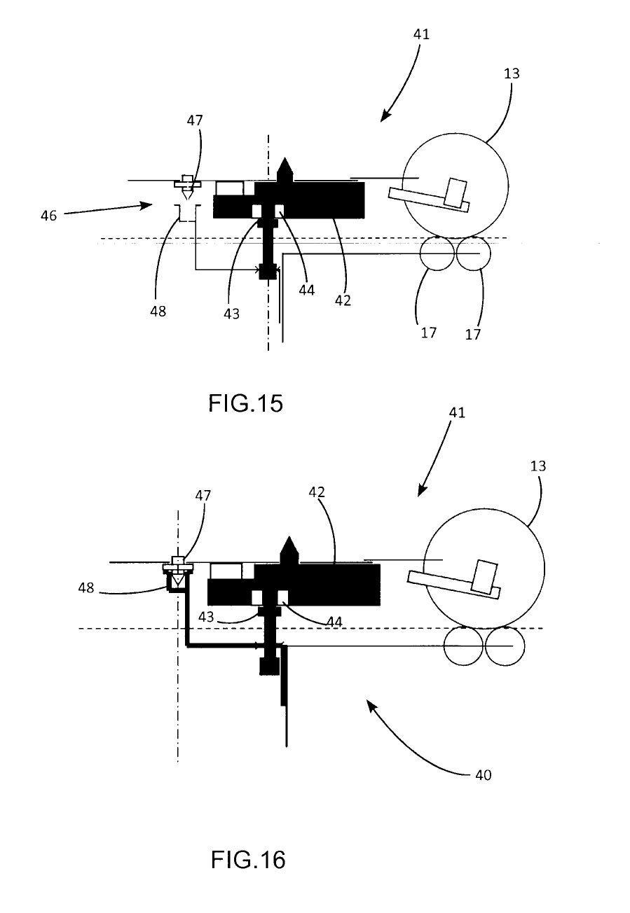

FIGS. 15 to 18 are schematic side views of the second embodiment of a system for replacing energy containers, a vehicle being in various situations in this system.

FIGS. 1 to 11 represent a first vehicle 11 in situ on a first embodiment of a system 10 for replacing energy containers 20 and FIGS. 13 to 18 represent a second vehicle 41 in situ on a second embodiment of a system 40 for replacing energy containers 42.

The first vehicle differs from the second vehicle in the installation of the energy container for powering its driving motor; on the first vehicle, it is installed in the rear trunk and on the second vehicle, it is installed under the chassis. Preferably, in both cases, the energy container is an electric battery for powering an electric motor for driving the vehicle. In the rest of the description, the replacement of an energy container is described through the description of the replacement of a battery for electrically powering a motor for driving a vehicle.

In the figures, the usual axes of the vehicle are shown. The longitudinal axis of the vehicle is marked X, the transverse axis of the vehicle is marked Y and the vertical axis of the vehicle is marked Z.

Before being positioned on the first embodiment of the system 10 for replacing batteries, the vehicle moves over a floor 80 by virtue of the action of its driving motor. In order to best position the vehicle relative to the battery-replacement system, the replacement system may comprise a rail 16 formed for example by two metal section pieces that are set apart designed to guide the front wheels 12 and rear wheels 13 on the driver side or passenger side of the vehicle. Thus, the driver drives the vehicle in order to position these wheels in the rail until the rear wheels of the vehicle are positioned between two rollers 17 of the replacement system placed perpendicular to the rail. In this position, each of the front wheels rests on a ball-bearing plate 18 or they rest collectively on a ball-bearing plate, this or these plates forming part of the replacement system.

Once the vehicle is in this position, the rotation of the rollers 17 and the rotation of the ball bearings of the plates 18 are released. This makes it possible to position the vehicle relative to the floor 80 or relative to a geocentric frame of reference about the longitudinal axis X and to rotate the vehicle relative to the floor 80 or relative to a geocentric frame of reference about the vertical axis Z.

Once the ball bearings of the plates 18 have been released, the latter can move freely perpendicular to the rail 16 or both perpendicular and parallel to the rail 16.

The rotation of the ball bearings and of the rollers is stopped during the phases in which the vehicle reaches the replacement system or leaves the replacement system, the vehicle then being driven by the action of its motor.

As shown in FIG. 2, the battery-replacement system also comprises a device for sensing the position of the motor vehicle along the transverse axis Y of the vehicle. This sensing device comprises for example two sensing means 31 resting against the lateral faces of the vehicle, for example resting against the two lateral faces of the wheels of the rear axle system of the vehicle. Thus, by virtue of the data supplied by the sensing means and, more generally, by the sensing means, one axis 32 of the battery-replacement system can be positioned relative to the vehicle.

This positioning is important as it allows the correct execution of the subsequent steps for positioning the vehicle and for removing the battery. This positioning makes it possible for example to locate the vehicle at more or less 15 mm relative to the floor.

Specifically, once the battery-replacement system has been positioned relative to the vehicle by virtue of the previous step, first positioning means 24 forming part of the battery-replacement system are moved to interact with second positioning means 23 provided on the vehicle, for example provided on a frame 21 surrounding the battery 20. The first positioning means and the second positioning means 23 form a first positioning device 22. The first positioning means are for example guide pins and the second positioning means are for example lugs, bars extending from the body of the vehicle or holes. As shown in FIGS. 3 to 7, the first positioning means preferably interact with the second positioning means by insertion of the first means into the second means or by insertion of the second means into the first means.

The interaction of the first and of the second positioning means makes it possible to refine the positioning of the vehicle relative to the floor and relative to the battery-replacement system, in particular along the longitudinal axis X of the vehicle and rotationally about the vertical axis Z of the vehicle.

Moreover, as shown in FIG. 5, bearing surfaces 25 of the battery-replacement system act on the body of the vehicle at the front of the latter. The function of these bearing surfaces is to lift the body of the vehicle in the front of the latter. A similar function is performed by the interaction of the first and second positioning means. Thus, the body of the vehicle can be placed in position relative to the floor and to the battery-replacement system along the vertical axis Z of the vehicle, but also be placed in position relative to the floor and to the battery-replacement system in rotation about the axes X and Y of the vehicle. In other words, the vehicle is brought to a determined attitude.

This positioning and this attitude placement make it possible for example to locate the vehicle to more or less 1 mm relative to the floor and relative to the battery-replacement system.

As shown in FIG. 8, once the vehicle is in this position, a pallet 25 is positioned beneath the battery for example by virtue of a lift table 26, that is to say that the battery attached to the vehicle is taken over by the battery-replacement system.

As shown in FIGS. 9 to 11, actuators 27, 28 of the battery-replacement system act on the pallet so that the latter exerts an upward vertical action on the battery so that the replacement system can withdraw the constraining linkage elements used to keep the battery on the vehicle. Once these constraining elements are withdrawn, the battery rests on the pallet, the latter being supported by the actuators 27, 28. In a subsequent step, the actuators place the pallet-battery assembly on the lift table 26 which can then carry the battery away.

In order to prevent the upward vertical action from changing the position of the vehicle or its attitude, the first positioning means may comprise a removable element 29 making it possible to absorb the vertical action exerted by the actuators 27, 28. As shown in FIG. 12, this removable element 29 may consist of a bar 29 that can rotate about the axis of the first positioning means between a “locked” first position in which the first positioning means can no longer come out of the second positioning means vertically and an “unlocked” second position in which the first positioning means can come out of the second positioning means vertically.

Such a machine for withdrawing the constraining elements and for absorbing forces therefore has a main effect of maintaining the attitude of the vehicle during the replacement method. This maintenance of the attitude is particularly advantageous and makes it possible to optimize the replacement method in terms notably of safety, reliability and repeatability.

A second embodiment of the replacement system is described below with reference to FIGS. 13 to 18. Before being positioned on the second embodiment of the battery-replacement system, the vehicle 41 moves on a floor 80 by virtue of the action of its driving motor. As in the first embodiment, in order to best position the vehicle relative to the battery-replacement system, the replacement system may comprise a rail 16 formed for example by two metal section pieces spaced apart designed to guide the front wheels 12 and rear wheels 13 on the driver side or passenger side of the vehicle. Thus, the driver drives the vehicle in order to position these wheels in the rail until the rear wheels of the vehicle are positioned between two rollers 17 of the replacement system placed perpendicular to the rail. In this position, each of the front wheels rests on a ball-bearing plate 18 or collectively on a ball-bearing plate, this or these plates forming part of the replacement system.

Once the vehicle is in this position, the rotation of the rollers 17 and the rotation of the ball bearings of the plates 18 are released. This makes it possible to position the vehicle longitudinally relative to the floor 80 or relative to a geocentric frame of reference along the longitudinal axis X and to rotate the vehicle relative to the floor 80 or relative to a geocentric frame of reference about the vertical axis Z.

Once the ball bearings of the plates 18 are released, the latter can move freely perpendicular to the rail 16 or at the same time perpendicular and parallel to the rail 16.

As shown in FIG. 2, the battery-replacement system also comprises a sensing device for sensing the position of the motor vehicle relative to the floor 80 or to a geocentric frame of reference along the transverse axis Y of the vehicle. This sensing device comprises for example two sensing means 31 resting against the lateral faces of the vehicle, for example resting against the two lateral faces of the wheels of the rear axle system of the vehicle. Thus, by virtue of the data supplied by the sensing means and, more generally by the sensing means, an axis 32 of the battery-replacement system can be positioned relative to the vehicle.

This positioning is important because it allows a good execution of the subsequent steps for positioning the vehicle and for removing the battery. This positioning for example makes it possible to locate the vehicle to more or less 15 mm relative to the floor.

Specifically, once the battery-replacement system is positioned relative to the vehicle by virtue of the previous step, first positioning means 43 forming part of the battery-replacement system are moved to interact with second positioning means 44 provided on the vehicle, in particular on the battery of the vehicle. The first positioning means 43 and the second positioning means 44 form a first positioning device 45. The first positioning means are for example guide pins and the second positioning means are for example lugs, bars protruding from the battery or holes. As shown in FIGS. 14 to 16, the first positioning means preferably interact with the second positioning means by insertion of the first means into the second means or by insertion of the second means into the first means.

The interaction of the first and second positioning means makes it possible to refine the positioning of the vehicle relative to the floor and relative to the battery-replacement system, in particular along the longitudinal axis X of the vehicle and rotationally about the vertical axis Z of the vehicle.

Once the first and second positioning means interact, the third positioning means 48 forming part of the battery-replacement system are moved to interact with the fourth positioning means 47 provided on the body of the vehicle. The third positioning means 48 and the fourth positioning means 47 form a second positioning device 46. The fourth positioning means are for example guide pins and the third positioning means are for example lugs or holes. As shown in FIGS. 15 and 16, the third positioning means interact preferably with the fourth positioning means by insertion of the fourth means into the third means or by insertion of the third means into the fourth means.

The interaction of the third and fourth positioning means makes it possible to refine the positioning of the vehicle relative to the floor and relative to the battery-replacement system, in particular along the longitudinal axis X of the vehicle and rotationally about the vertical axis Z of the vehicle.

The second positioning device is used to position the vehicle more accurately than the first device does.

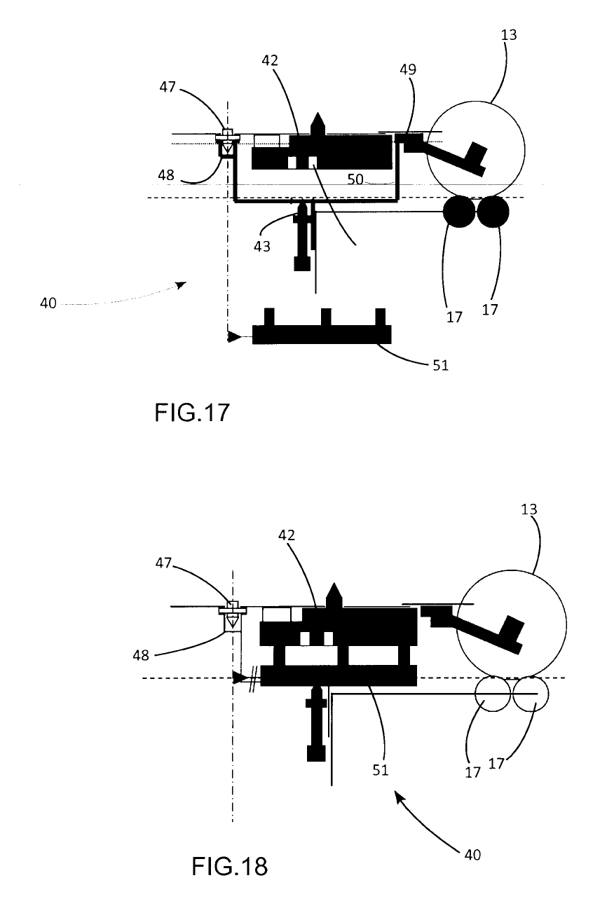

Once the third and fourth positioning means of the second positioning device interact, the interaction of the first and second positioning means of the first positioning device as shown in FIG. 17 can be brought to an end.

Moreover, the second positioning device makes it possible to act on the body of the vehicle for example in front of the battery and the replacement system comprises one or more arms 50 making it possible to act also on the body of the vehicle on a bearing surface 49 for example behind the battery. The function of these actions is to lift the body of the vehicle. Thus, the body of the vehicle may be placed in position relative to the floor and to the battery-replacement system along the vertical axis Z of the vehicle, but also be placed in position relative to the floor and to the battery-replacement system rotationally about the axes X and Y of the vehicle. In other words, the vehicle is brought into a defined attitude.

This positioning and this placement in attitude make it possible for example to locate the vehicle to more or less 1 mm relative to the floor and relative to the battery-replacement system.

As shown in FIG. 18, once the vehicle is in this position, a pallet 51 is placed under the battery for example by virtue of a lift table (not shown), that is to say that the battery attached to the vehicle is taken over by the battery-replacement system.

The battery may then be removed as described above with reference to FIGS. 9 to 11. More particularly, a mechanism for withdrawing the constraining elements and for absorbing forces is used so as to maintain the attitude of the vehicle during the replacement of the battery (FIGS. 9 to 11).

The replacement system that is the subject of the invention clearly comprises, in addition to the hardware means described above, software means allowing the hardware means to act in sequence in order to apply the replacement method that is the subject of the invention. The software means may notably comprise computer programs.

1. A method for replacing a container (20; 42) of energy for powering a motor for driving a motor vehicle (11; 41) resting on a floor and comprising a longitudinal axis (X), a transverse axis (Y) and a vertical axis (Z), the replacement method comprising a first step of positioning the motor vehicle relative to the floor (80) in the absence of action of a motor for driving the motor vehicle, which replacement method being characterized in that it comprises a step of withdrawing the constraining linkage elements linking the energy container to the motor vehicle.

2. The replacement method as claimed in the preceding claim, characterized in that said step of withdrawing the constraining linkage elements comprises a locking of means (29) for absorbing vertical forces applied to the energy container and bringing a pallet (25; 51) into contact with the energy container, said pallet (25; 51) being previously positioned under the energy container of the motor vehicle.

3. The replacement method as claimed in the preceding claim, characterized in that said locking of means for absorbing vertical forces comprises the rotation of a removable element (29), capable of absorbing the vertical forces exerted by actuators (27, 28), so that the attitude of the motor vehicle is not modified.

4. The replacement method as claimed in one of the preceding claims, characterized in that the first positioning step comprises:
positioning the motor vehicle relative to the floor along the longitudinal axis, and/or
positioning the motor vehicle relative to the floor about the vertical axis.

5. The replacement method as claimed in one of the preceding claims, characterized in that it comprises a second step of positioning a system (10; 40) for replacing an energy container for powering a motor for driving a motor vehicle relative to the motor vehicle.

6. The replacement method as claimed in claim 5, characterized in that the second positioning step comprises:
positioning the replacement system relative to the motor vehicle along the transverse axis.

7. The replacement method as claimed in one of the preceding claims, characterized in that it comprises a third step of precise positioning of the motor vehicle relative to the floor in the absence of action of a motor for driving the motor vehicle.

8. The replacement method as claimed in claim 7, characterized in that the third positioning step comprises:
positioning the motor vehicle relative to the floor along the longitudinal axis, and/or
positioning the motor vehicle relative to the floor about the vertical axis,
by interaction of positioning means (23, 24; 43, 44, 47, 48).

9. The replacement method as claimed in one of the preceding claims, characterized in that it comprises a fourth step of positioning the body of the motor vehicle relative to the floor.

10. The replacement method as claimed in claim 9, characterized in that the fourth positioning step comprises:
positioning the body of the motor vehicle relative to the floor along the vertical axis, and/or
positioning the body of the motor vehicle relative to the floor about the longitudinal axis, and/or
positioning the body of the motor vehicle relative to the floor about the transverse axis.

11. The replacement method as claimed in one of the preceding claims, characterized in that it comprises a fifth step of the energy container being taken over by the replacement system.

12. The replacement method as claimed in the preceding claim, characterized in that said step of withdrawing the constraining linkage elements is carried out after said fifth step of the energy container being taken over by the replacement system.

13. A system (10; 40) for replacing an energy container (20; 42) for powering a motor for driving a motor vehicle (11; 41), characterized in that it comprises hardware means (17, 18, 31, 32, 22, 25, 26, 27, 28, 29; 17, 18, 31, 45, 46, 51) and/or software means for applying the replacement method as claimed in one of the preceding claims.

14. A station for replacing an energy container for powering a motor for driving a motor vehicle, characterized in that it comprises a replacement system as claimed in one of the preceding claims.
